(19) United States
(12) Patent Application Publication
(10) Pub. No.: US 2009/0309264 A1
(43) Pub. Date: Dec. 17, 2009

(54) METHOD OF PRODUCING STIFFENED PANELS MADE OF A COMPOSITE AND PANELS THUS PRODUCED

(75) Inventor: Frederick Cavaliere, Montigny le Bretonneux (FR)

Correspondence Address: Perman & Green, LLP, 99 Hawley Lane, Stratford, CT, 06614, US

(73) Assignee: EADS FRANCE, Paris (FR)

(21) Appl. No.: 12/298,104

(22) PCT Filed: Mar. 20, 2007
(86) PCT No.: PCT/EP2007/052622

§ 371 Date: Feb. 23, 2009

(30) Foreign Application Priority Data
Mar. 20, 2006 (FR) 0650957

(51) Int. Cl. B29C 70/44; B29C 33/50

(52) U.S. Cl. 264/319

(57) ABSTRACT

A stiffened panel made of a composite includes a skin and at least one stiffener having a more or less closed volume. In order for the fibres of the composite to be held in place during fibre deposition and during pressure application while the resin of the composite is being cured, a moulding core is placed between the fibres at the position of the more or less closed volume of the stiffener. The moulding core includes a flexible bladder filled with a granular solid material, the thermal expansion coefficient of which is close to that of the composite used to produce the stiffened panel. The pressure in the bladder is increased before the composite is cured, so as to compensate for the forces applied for compressing these fibres during production of the panel.

### CROSS-REFERENCE TO RELATED APPLICATIONS

This application is the National Stage of International Application No. PCT/EP2007/052622, International Filing Date 20 Mar. 2007, which designated the United States of America and which International Application was published under PCT Article 21 (2) as WO Publication No. WO2007/107553 A1 and which claims priority to French Application No. 06 50957, filed 20 Mar. 2006, the disclosures of which are incorporated herein by reference in their entireties.

### BACKGROUND

1. Field

The disclosed embodiments relate to the field of complex shapes made of composite materials requiring molds during the manufacturing operations. More particularly, the aspects of the disclosed embodiments are applied to structural panels that are flat or present curvatures, and may be single or double, such as the panels or sections used in the manufacture of aircraft fuselage, whose stiffening elements require the use of molding cores that are trapped at the time of the preparation of the panel and must be extracted from it during the course of the manufacturing process.

2. Brief Description of Related Developments

The pieces made of composite materials which comprise fibers in a matrix, for example, a resin, are usually made using molds that are intended to give the shape of said piece to the material.

The dry, or previously resin-impregnated, fibrous material is deposited on the mold whose shape it must follow, and undergoes a more or less complex cycle that can comprise phases of resin injection and/or pressurization and/or heating.

After the curing of the resin, which is often carried out by polymerization, the piece that is in the process of being produced has reached the desired mechanical and dimensional properties, and it is withdrawn from the mold.

The stiffened panels are pieces that have complex shapes, not only because of the curvatures of some of these pieces, but also because of the structural elements that they contain, which are indispensable to ensure the shape of the panel and its rigidity. The production of these structural elements sometimes requires the use of molds that present some elements that are trapped in the piece at the time of removal from the mold. This is frequently the case with stiffeners whose enclosing shapes require the mold to comprise special elements, cores that fill the hollow zones located between the panel and the stiffener during the production of the piece.

The cores, which are blocked as soon as the hollow zone is more or less enclosing, must then be extracted without damaging the piece that has just been produced. Because of the dimensions of the pieces in question, and the generally very elongated shapes of the stiffeners, it is difficult to extract the cores safely.

In some cases, it is possible to produce cores made of several assembled elements to be extracted in parts. However, such cores are complex and expensive to produce, they do not allow the obtention of all the shapes encountered, and the interfaces between the different elements leave undesirable cavities in the composite material.

Another method that is also used consists in producing the core from a material that allows the destruction of said core to eliminate it from the piece, for example, by a mechanical action, or by melting or dissolution of the material of the core. In this case, the difficulty consists in finding a material to produce the core which is economically acceptable or capable of resisting the sometimes extreme conditions encountered during the process of the production of the piece made of composite material, which is sufficiently stable to resist the handling operations and the mechanical and thermal stresses during the preparation of the piece while respecting the stringent shape-related tolerances, and which can be eliminated mechanically or by melting without risk of damaging the piece, or be dissolved by water or by another solvent that is compatible with the material of the piece. These combinations of conditions are not always possible, particularly given that the production of the stiffeners requires in general cores of small section and large length, which are difficult to handle because of their fragility, and, in every case, as many cores or sets of cores have to be manufactured as there are pieces to be produced, which, combined with the phase of elimination of the core, and compliance with the applicable hygiene and security conditions, is expensive on the industrial scale.

Another known method consists in producing a core from a material that is sufficiently deformable, so that said core can be extracted by deformation. Thus, a core made of an elastomer, which optionally comprises recesses, can be extracted by drawing and striction through the opening that exists generally at the end of the stiffener. A defect of cores that use deformable material is their dimensional instability due to their low rigidity, which prevents the reproduction, within the tolerances required for certain applications, of the results during the manufacture of the pieces. In addition, the low stricture coefficient prevents a solution in situations where there are significant variations in the section of the core or large curvatures. Moreover, because of the contact surface between the elongated core and the walls of the piece, the frictional forces make the extraction difficult and risk damaging the piece.

To produce a core that is both rigid and can be extracted from the piece after curing, a solution consists in producing a bladder from an elastomer material, which bladder is filled with a granular material. In a first step, the bladder, whose shape is preferably produced in the desired shape of the core, is placed in a mold, against the walls of which a depressurization means is applied, between the walls of the bladder and those of the mold corresponding to the desired shape of the core. After filling the bladder with the granular material, the reduced pressure between the walls of the mold and of the bladder is broken off, and a vacuum is applied to the interior of the bladder, which has the effect of compacting and blocking, under the crushing forces of the bladder, which is subjected to atmospheric pressure, the granular material contained in said bladder, which thus confers to the latter a stable shape and the rigidity desired to serve as a support for the placement of resin-preimpregnated fabrics. After the curing of the resin, the vacuum in the interior of the bladder is broken, and the bladder is opened to extract the granular material. The emptied envelope of the bladder is then sufficiently deformable to be removed from the piece made of composite material, in which it is trapped. The U.S. Pat. No. 5,262,121 describes such a method for producing complex ductwork made of composite material. A problem that arises with this type of production is that the dimensional quality of the piece produced may be insufficient. This quality is indeed affected by the variations in the effective dimensions of the core after the application of the vacuum, and by those due to handling operations during its placement, and to the heating and pressure cycles that are generally used for the polymerization of the resin, notably because the method uses no other reference shape for the piece except that of the core.

In the case of cores of large dimensions, which are used for the production of the stiffened panels, the sensitivity to deformations is increased by the expansion of the pieces during the course of the variations of the temperatures used by the methods for producing pieces made of composite material. These dilations can generate large differences in shape and nonhomogeneous pressures that generate defects in the piece produced.

While these variations in the dimensions and other defects do not constitute damage for the very common, relatively massive, composite pieces, such as, for example, air conditioning ducts, they are generally not acceptable for the production of high-performance composite pieces, such as, for example, structural pieces with narrow geometric tolerances, which are intended for precise assemblies and whose dimensional characteristics are often critical as is the structural integrity of the material of the finished piece, which must not contain any gas bubbles or porosities, pockets of resin, or “dry” fibers, all phenomena that lead to high manufacturing rejection rates, and are sources of delamination, if the piece is subjected to stresses during service, this leads to designing pieces where structural resistance is essential given the excess dimensions, which in turn results in a detrimental increase in weight, particularly in aeronautic applications.

A defect that is also present in the known methods that use cores is connected with the fact that each one of these methods fails to take into account the variation in the thickness of the composite material during the curing process. Said known processes use cores whose properties of rigidity and/or possibility of extraction are sought, but whose dimensions do not meet the needs in the different steps of the procedures of production of the composite materials during which the thickness of the composite material evolves.

### SUMMARY

To produce stiffened panels made of a composite material, and presenting geometric and structural characteristics that are compatible with applications of the aeronautic type, the aspects of the disclosed embodiments use a molding core that is capable of filling the zones that have to remain hollow between the panel and the stiffeners.

A stiffened panel made of composite material comprises a skin and at least one stiffener, where said composite material comprises fibers coated with a resin that changes from a pasty or liquid state to a solid state during the course of the curing phase, where the fibers determine at least one hollow form, which is elongated, i.e., it has one dimension, the length, that is large compared to the other dimensions that are substantially orthogonally with respect to the length, and which is formed by the surfaces of the at least one stiffener and of the skin. According to the aspects of the disclosed embodiments, a volume that corresponds entirely or in part to the at least one hollow form is occupied by the core, where said core comprises a bladder made of a flexible material that presents an external surface delimiting a volume of the core whose shapes and dimensions are in agreement with the volume of the hollow form, and present an internal surface determining a volume of the bladder, which volume is filled with a granular solid material chosen from materials having a thermal expansion coefficient that is substantially equal to the thermal expansion coefficient of the composite material used to produce the stiffened panel. Thus, during temperature variations in the course of the manufacture of the panel made of composite material, such as during the thermal curing that is used for curing the composite material, the core, which has a complex and reusable shape, and the stiffened panel dilate and contract simultaneously, and with comparable elongations, to avoid introducing stresses and deformations in the stiffened panel.

To place the core precisely and to avoid local deformations of the panel, the core is produced with a section whose dimensions are less than that of the desired hollow form in the panel to take into account the decrease in the thickness of the composite material during the curing phase. More precisely, the core is produced with dimensions corresponding to those of the hollow form in the composite material before the curing phase.

It is advantageous for the granular solid material used to fill the bladder to be a material or a mixture of materials whose thermal expansion coefficients are between 3 10E-6 per Kelvin and 9 10E-6 per Kelvin, for example, a borosilicate glass or an iron-nickel alloy of the Invar type with low expansion coefficient.

To produce a core that can be handled without undergoing deformation, when it is placed in the mold, a pressure Pn of an intergranular fluid contained in the bladder is decreased, during a preparation step of the core, in such a way that the walls of the bladder compact the granular solid material due to the effect of the crushing forces of the bladder, which are connected with a pressure, such as, atmospheric pressure, that is exerted on the external surface of the bladder made of flexible material and confer a stable shape to the core.

To prevent local deformations of the core and thus of the panel due to the effect of the pressures exerted by the method for the production of the composite material and to improve the material integrity of the panel, the pressure Pn of an intergranular fluid contained in the bladder is increased during the phase of curing the resin in such a way that the pressure in the core Pn substantially balances the forces exerted by the pressurization means of the composite material, in such a way that the fibers of the composite material are compressed without being deformed.

For example, when the method for the production of the composite material uses an external bladder that is subjected to an autoclave pressure Pa, the pressure Pn is increased to a value that is substantially equal to the pressure Pa.

In a simple installation, the intergranular fluid is subjected to the autoclave pressure Pa in such a way that Pn is substantially equal to Pa.

To take into account the non-negligible thickness of the bladder due to the small section of the core, the pressure Pn of the intergranular fluid is equal to the autoclave pressure Pa, corrected to compensate for the difference between the external surface of the core, which is subjected to the autoclave pressure, and the internal surface of the bladder, which is subjected to the pressure of the intergranular fluid opposite said external surface that is subjected to the autoclave pressure.

When the method for the production of a composite material uses an injected resin, for example, in the RTM method, the pressure Pn of the intergranular fluid is increased to a value that is at least equal to the injection pressure of the resin in the closed mold.

To improve the homogeneity of the temperature in the mold, particularly when the resin is cured by thermal curing, the core is filled with a granular solid material and/or an interstitial fluid chosen to have a thermal conductivity coefficient that can ensure the diffusion of heat and the homogeneity of the temperature during the thermal curing.

When the stiffened panel made of composite material is produced, the pressure Pn in the bladder of the core is decreased advantageously to a value below atmospheric pressure, after it has been emptied, at least partially, of the granular solid material.

The disclosed embodiments also relate to a stiffened panel which is made of a composite material comprising a skin and at least one stiffener that is fixed to one face of said skin, and presents improved structural resistance and dimensional quality by means of the inclusion in a step of its production of at least one core that is trapped in the stiffened panel, where said core comprises a flexible bladder filled with a granular solid material whose expansion coefficient is close to the expansion coefficient of the composite material of said stiffened panel.

Depending on the geometry of the forms produced, and particularly of the stiffeners, the core is trapped, at least over a part of its length, in a volume having a closed section delimited by an internal surface of the section of a stiffener and optionally a part of the face of the skin to which the stiffener is fixed, or the core is trapped, at least over a part of its length, in a volume having an open section delimited by a surface of the section of a stiffener and optionally a part of the surface of the skin to which the stiffener is fixed.

### BRIEF DESCRIPTION OF THE DRAWINGS

The detailed presentation of an aspect of the disclosed embodiments is given in reference to the drawings which represent:

FIG. 1a: a panel stiffened with so-called Ω profile stiffeners;

FIGS. 1b and 1c: details of the stiffened panel of FIG. 1a showing an example of the shape of a stiffener along its length and an example of the section of a panel perpendicular to a stiffener;

FIG. 2: a core being prepared in a mold for shaping the core;

FIG. 3: a core that is ready to be used for the production of a stiffened panel;

FIGS. 4a, 4b, 4c: three steps of the production of the panel according to the method using a core that is in conformity with the core of FIG. 3;

FIG. 5: a panel produced according to the disclosed embodiments before the extraction of the core;

FIGS. 6a, 6b, 6c: different non-limiting sections of stiffeners for which the aspects of the disclosed embodiments are advantageously used.

### DETAILED DESCRIPTION OF THE DISCLOSED EMBODIMENTS

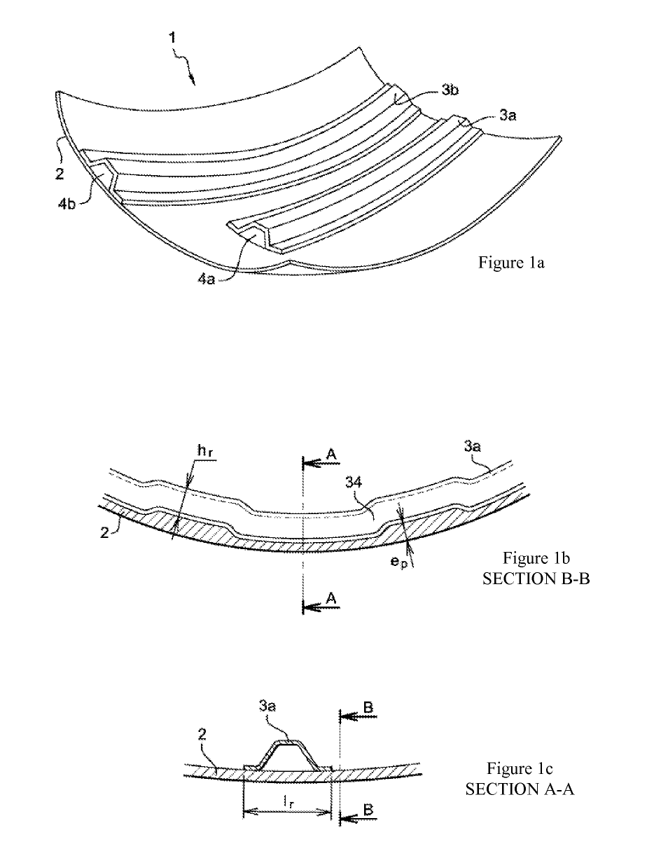

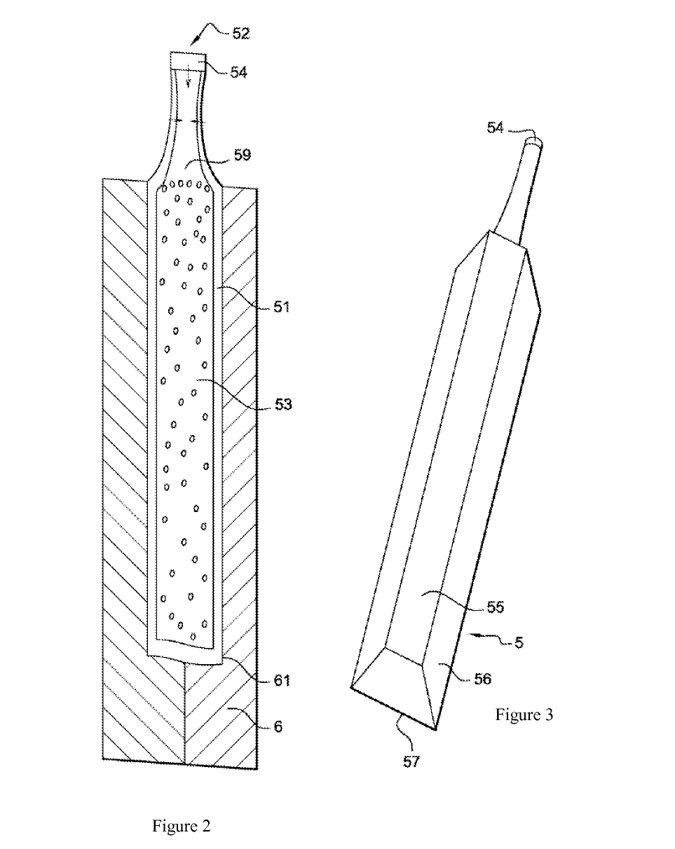

FIGS. 1a, 1b and 1c represent, as a non-limiting illustration, a stiffened panel which is made of a composite material, which comprises a skin 2 and stiffeners 3a, 3b on one of the faces of the skin, and which is produced advantageously according to the aspects of the disclosed embodiments.

The composite materials to which the disclosed embodiments refer are preferably the materials that comprise fibers, such as, for example, glass, carbon or aramide fibers of the Kevlar® type, which are trapped in an organic matrix, such as, for example, a polyester resin or an epoxy resin, and used for the production of panels and pieces presenting varying degrees of relief.

These types of composite materials are used extensively today in numerous industrial sectors, particularly in aeronautics, for the production of pieces used in airplane structures that must bear large loads.

The skin 2 is a structure of small thickness compared to its other dimensions, the length and the width. 2 can have a thickness ep that is substantially constant, but in general the thickness is often different depending on the point considered on the surface of the panel 1, as illustrated in the detail 1b, to obtain a structural resistance that is adapted to the forces to be transmitted by the skin 2. In practice, this thickness always remains small compared to the length and the width.

In contrast to the skin, a stiffener 3a, 3b is a structural element of elongated form, i.e., it presents a dimension, the length, which is large compared to the transverse dimensions, the width lr, and the height hr of the stiffener. The width lr corresponds to the transverse dimension of the stiffener in parallel to the plane of the skin, when the stiffener is fixed to the skin, and the height hr of the stiffener corresponds to the dimension perpendicular to this plane. The term plane denotes the plane that is tangential to the point considered, because the stiffened panels often comprise simple or double curvatures.

The stiffeners 3a, 3b are shown in a non-limiting illustration of the Ω shape in FIG. 1a. Numerous shapes of stiffeners can be used. The stiffeners comprise generally one or two bases and at least one core which confer to them a characteristic that is often identified by a letter that best characterizes this section. For example, stiffeners can be found in the shape of a Ω, a Z, a I, a C, a T . . . .

In addition, a stiffener is fixed to the skin over most of its length, and it follows generally the surface of the skin. Consequently, as illustrated in the detail of FIG. 1b, the stiffener does not only present an overall curvature that is in conformity with the curvatures of the panel, it also presents locally deviations 34, for example, when the thickness ep of the skin evolves.

The term stiffener also denotes all the structural elements of elongated shape, which are connected to the panel and contribute to the structural stability of the panel and/or to the resistance of the structure in which the panel is to be used. Depending on their shapes and their locations, these structural elements are sometimes called stiffeners, spars, ribs or frames. In the remainder of the description, the term stiffener will be used to denote any elongated structural elements that are fixed to a panel to contribute to its rigidity and/or its structural resistance.

To produce the panel 1 illustrated in FIG. 1a, one uses at least one core 5 that fills the hollow form 4a, 4b of the stiffener 3a, 3b during certain operations of the manufacture of the panel.

The core 5 is made from flexible bladder 51 made of an elastomer, for example, a silicone resin, whose envelope is produced by conventional means, for example, by molding or by injection, and with a shape and external dimensions that approximate as close as possible the desired shape and dimensions for the core. This form and these dimensions of the core correspond substantially to the shape and the dimensions of the hollow form 4a, 4b, which must be formed in the panel after the retraction of the core, which should be corrected to take into account the expansion of the uncured composite material.

Indeed, the core 5 must be put in place in a volume that is determined by the uncured composite material whose thickness, which has not yet been subjected to the pressures of the manufacturing procedure, is greater than the thickness that will be obtained after curing the composite material. The expansion is variable depending on the method used to deposit the fibers; this is a known and perfectly measurable phenomenon. It represents generally several percents of the thickness of the composite material, which is sufficient to hinder in the positioning of the core and cause unacceptable defects on the stiffened panel, if the core is made to the exact dimensions of the hollow form that is to be produced. To compensate for the phenomenon of expansion of the uncured composite material, the core is thus made advantageously with smaller dimensions, as a function of the value of the expansion, than the dimensions of the hollow form to be created.

The bladder comprises at least one opening 52 having at least one of its ends that remains accessible when the hollow core fills the hollow form of the panel. To produce the core, the bladder 51 is placed on a shaping tool 6 which comprises a hollow form 61, which reproduces substantially the hollow form 4a, 4b that is to be occupied by the core 5 during the production of the panel, and then it is filled through the opening 52 with a granular solid material 53.

The tool 6 consists, for example, of a mold that comprises, in this instance, two or more elements that can be disengaged from each other to place the bladder in the hollow form 61 and to extract the core 5 that is ready to be used.

When the bladder 51 is filled with the granular solid material 53, a reduced pressure is generated in the interior of the bladder by the aspiration of an intergranular fluid 59, for example, air, if the filling with the granular solid material is carried out in the atmosphere. Alternatively, other gases, gaseous mixtures or liquids are used as intergranular fluid. The reduced pressure generated by means that are not represented, for example, a vacuum pump, is maintained in the bladder 51 either by maintaining a depressurization connection, or simply by closing the opening through which the reduced pressure is generated by means of a closure means 54 that forms a seal with respect to the intergranular fluid.

Due to the effect of the atmospheric pressure on the exterior of the bladder 51, said bladder is subjected to crushing forces that compress and compact, because of the flexibility of the elastomer material of the wall of the bladder 51, the elements made of granular solid material 53. This compacting has the effect of stabilizing the shape of the core, which can be removed from the mold 6 while preserving the shape that it has acquired in the hollow cavity 61 of said mold.

Because of its pronounced elongation, given by the ratio of its length to its section, the core 5 preserves a certain, very relative, flexibility allowing the placement of said core in the position that it must occupy during the production of the panel while benefiting from a small but real possibility of deformation, particularly for the large curvatures.

When the stiffener comprises variations in the section and/or the curvatures 34 that are locally relatively small, the core 5 that has been taken out of the mold 6 reproduces these special shapes to the extent that the residual flexibility of said core does not allow an easy correction of the shape for such variations in shape.

In an embodiment of the stiffened panel 1, one uses a mold 8 whose surface 81 presents the general shape that is desired for the skin 2 and comprises at least one hollow form 82 corresponding to the cavity of the at least one stiffener 3a, 3b, which is to be produced on a face of the skin located on the side of the mold 8, during the production of the panel.

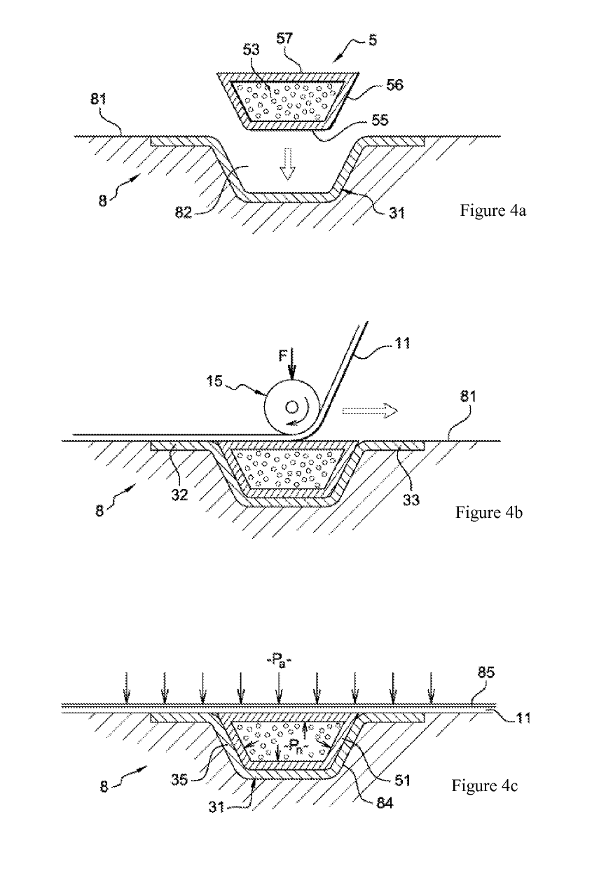

In a first step, which is presented in FIG. 4a, fibers 31, for example, preimpregnated fibers that are to constitute the at least one stiffener are deposited in the hollow form 82. The fibers 31 are deposited in general in the hollow form 82 in the form of preforms that are produced beforehand by known methods that are not represented, for example, by means of draping machines that deposit, on supports of appropriate shape, the fibers in strands or successive folds in the form of bands that are more or less broad, and more or less long, while respecting the orientation of the fibers and the number of planned folds. When all the planned folds to form the at least one stiffener have been deposited on the mold 8, the core 5, which is produced as described above, is placed in the hollow form 82, in such a way that the deposited fibers 31 are located between the mold 8 and the core 5.

In a second step, which is presented in FIG. 4b, the fibers 11 of the skin are deposited on the surface 81 of the mold 8, and they cover, on the one hand, the fibers 32, 33, which are deposited to form a base of the at least one stiffener, in the contact zones between the at least one stiffener 3a, 3b, and, on the other hand, the skin 2 and, on the other hand, the core 5. Because of its rigidity, which is obtained notably by the compacted granular solid material 53 contained in the bladder, the core 5 is capable of withstanding the forces F exerted by the means, shown schematically by the deposition head 15, for depositing the fiber folds 11 of the skin, which forces are generally necessary for the fibers to be compacted against each other, a condition that is necessary to obtain a good positioning of the folds, a good orientation of the fibers, and a good integrity of the finished composite material. The correct positioning of the fibers is also obtained by the choice of a core that takes into account the dimensions of the location filled by said core at the time of the deposition of the fibers, and allows the reconstitution of the surface on which the fibers of the skin 2 are deposited, without notable deformation.

In a third step, which is presented in FIG. 4c, a pressure Pa is applied to the surface of the fibers 11 that have been deposited opposite the surface in contact with the mold 8, and the temperature is increased, in a known way, according to a cycle that is determined to cause the curing of the resin that impregnates the fibers. This pressure Pa or autoclave pressure is obtained, for example, by means of a bladder 85 that covers the fibers deposited on the mold and is subjected to an external pressure, which is optionally completed by a depressurization of the space between the external bladder 85 and the mold 8, i.e., the space in which the fibers 11 are located. In addition, to prevent the autoclave pressure from deforming the skin 2, during the curing of the resin, at the level of the stiffener 3a, 3b, by a local crushing of the core 5 because of the flexibility of the wall of said bladder 51 and/or because of the insertion of the core 5 in the cavity 82 of the stiffener, due to the compaction of the fibers 31 of the stiffener, which would have the effect of creating simultaneously a local loss of the structural property of the skin 2 and geometric defects on the surface of the stiffened panel, which are incompatible with certain applications, such as, applications in which the surface is in contact with aerodynamic flow, the pressure Pn of the intergranular fluid contained in the bladder 51 is increased up to a value capable of compensating for the autoclave pressure Pa that is exerted through the walls of the bladder 85, and preventing the local deformation of the skin 2.

This increase in the pressure Pn in the bladder 51 has the effect of correcting the volume of the core 5 whose dimensions were chosen preferably to take into account the expansion of the uncured composite material and its decrease in thickness during the course of its curing due to the effect of the applied pressures.

One way of achieving the increase in the pressure Pn consists in connecting the internal volume of the bladder 51, which contains the intergranular fluid 59, to the means for generating the autoclave pressure, in order to increase the pressure Pn in the bladder at the same time as the autoclave pressure Pa is increased.

The pressure Pn of the intergranular fluid can be chosen to be equal to the autoclave pressure Pa.

However, the bladders 51 of cores for stiffeners have, according to the characteristics of the stiffeners, relatively small sections. Consequently, the characteristic dimensions of the sections of the emptied zone of the bladder, notably the width li, are substantially smaller than those of the corresponding external sections, the width le, because of the thickness of the elastomer bladder, which is not negligible compared to the other dimensions of the sections. Because of this substantial difference between the internal dimensions and the external dimensions of the bladder of the core, the pressure on the external surface, which is generated by the pressure Pn in the bladder, is lower than the internal pressure Pn, and thus lower than the pressure Pa, if the internal volume of the bladder is subjected to the autoclave pressure.

The pressure Pn applied to the interior of the bladder 51 to compensate for the forces due to the autoclave pressure Pa is corrected advantageously to take this effect into account. For example, a multiplication coefficient taking into account the thickness of the bladder 51 is applied to the autoclave pressure Pa, to obtain a value of the pressure Pn in the core which restores an apparent pressure that is substantially equal to Pa on the external face of the core that is subjected to the autoclave pressure. The pressure in the core is preferably controlled using the value that is desired when the autoclave pressure is applied. The pressure in the core is obtained advantageously automatically by connecting the internal volume of the bladder of the core to the autoclave pressure by means of a piston-based pressure multiplier.

The pressure Pn also has the effect of compressing the fibers of the web 35, 36, 37 of the stiffener on the corresponding surfaces 84, 85 of the cavity 82 in the mold 8, which is partially achieved by the forces that the autoclave pressure Pa exerts on the core 5, which pushes against the inclined webs 35 of the stiffeners, and which is not achieved if the surfaces 85 of the cavity, against which the webs the stiffeners rest, are close to the line perpendicular to the surface of the skin 2.

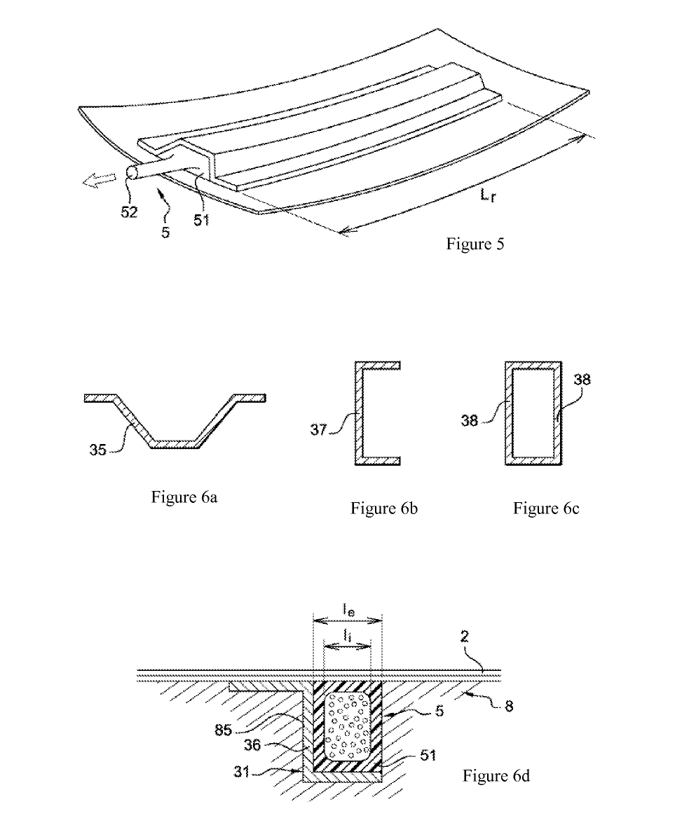

In a fourth step, FIG. 5, after the curing of the resin, the autoclave pressure Pa and the pressure Pn in the bladder 51 are balanced with the work pressure, in general the atmospheric pressure, and the stiffened panel 1 is disengaged from the mold 8.

The core 5 is then emptied at least partially of the granular solid material 53 that it contains, through the opening 52 so that the bladder 51 becomes sufficiently deformable to be withdrawn through an accessible end of the stiffener. A reduced pressure is created advantageously in the bladder 51, which has been emptied of the granular solid material, which has the effect of causing a crushing of said bladder due to the effect of the atmospheric pressure, which in turn facilitates the detachment of the walls 55, 56, 57 of the bladder from the surfaces of the hollow form 4a, 4b of the stiffener, and facilitates the extraction of the bladder.

The granular solid material 53 used for filling the bladder 51 is formed, for example, from metal or glass elements. The elements of the granular solid material preferably present:
dimensions that are sufficiently small to fill the bladder including in the zones where the core presents a reduced section;
shapes that are sufficiently blunt, for example, spherical shapes, so that the elements flow easily during the filling of the bladder or when the latter is emptied of said elements, and for the purpose of facilitating the draining and the circulation of the intergranular fluid between said elements during the depressurization or during the pressurization of the bladder; and
are made from a material that is chosen as a function of its thermal expansion coefficient, taking into account the expansion of the stiffened panel during its fabrication; and
made from a material that is chosen as a function of its thermal conductivity coefficient, when a good conduction of heat in the mold is sought.

Because of the very elongated shape of the cores 5 used for the production of stiffened panels, the selection of a granular solid material 53 having an adapted thermal expansion coefficient is essential, because, while the expansion in the direction of the width lr and of the height hr of the core 5 is negligible, because of the relatively small dimensions involved, the expansion becomes critical over the length Lr of the core. For example, an economic and relatively light material that is used to fill a bladder, such as, aluminum, with an expansion coefficient of 24 10E-6 per Kelvin, induces, during thermal curing where the temperature is increased by 200 Kelvin, an elongation of the core on the order of 5 mm per meter. Such an elongation is totally incompatible with the production of a piece made of composite material that has dimensions of up to several meters while complying with the qualities required for an aeronautic structure.

The granular solid material 53 is thus selected advantageously from materials whose expansion coefficient is closer to the expansion coefficient of the composite material used for the production of the stiffened panel.

The composite materials present generally a low thermal expansion coefficient, on the order of 3 to 5 10E-6 per Kelvin. In this case, it is preferred to choose a borosilicate glass, which is a glass with a high silicon content and an expansion coefficient on the order of 3.5 10E-6 per Kelvin, or an alloy of iron that is rich in nickel, of the “Invar” type, with low expansion coefficient, as granular solid material 53. In this way, the composite material of the stiffened panel 1 and the core 5 dilate and contract jointly with the changes in temperature, which prevents the introduction of undesired residual deformations and stresses into the panel.

The process described for the production of a stiffened material made of composite material from preimpregnated fibers deposited on a mold that comprises a form is adapted easily to other methods for the production of pieces made of composite material.

For example, the pressure that is exerted by means of an external bladder 85 and an autoclave pressure Pa is, in some cases, achieved by means of a counter-form that may be rigid or it can be produced, at least in part, from an elastomer. In this case, the pressure Pn in the core is increased during the phase of curing the resin to a value that is close to the pressure that is sought to apply the counter-form in the method.

For example, in some methods by resin transfer, called RTM, the fibers that are deposited in a dry state, i.e., they have not been preimpregnated with a resin, in a mold, generally a form and counter-form which are assembled when the fibers are in place, and the resin is injected in the mold whose walls determine precisely the shapes of the panel. In this case the pressure Pn in the bladder 51 is chosen preferably to be at least equal to the pressure of the resin in the mold or greater, as a function of the desired compression for the fibers in the zone of the stiffener.

The method according to the disclosed embodiments, which are described for a so-called Ω shape stiffener, is applicable to the other stiffener shapes, since, on the one hand, the problems of dimensional stability of the core, which the aspects of the disclosed embodiments solve, are always critical, and the generation of a counter pressure in the core to counter the pressure exerted on the skin is always necessary, to guarantee the quality of the composite material in the zone of the stiffener, even if the skin 2 is not in direct contact with the core 5, as in the example of the stiffeners of FIGS. 6b and 6c. As illustrated in FIG. 6d, the production of a core having the shape that is adapted to the volume that is to be filled during the production of the piece allows the method to be carried out. It should be noted that the method is applied advantageously even if the hollow forms are not totally, or not at all closed, since the rigid cores or the cores made of elastomers do not allow the application of a counter pressure that can prevent local formation of the skin or of the stiffener, and, since the extraction of the core without damaging the panel may be made difficult if not impossible due to the variations in the section of the stiffeners over the large lengths and/or the special shapes of the stiffener, for example, in a twisting connected with the curvature of the panel, and/or of the variations in the thickness of the skin. In addition, the pressure Pn in the interior of the bladder makes it possible to create a pressure that is perfectly controlled on the webs 36, 37, 38 of the stiffeners, which, as they are located close to the line perpendicular to the local surface of the skin, are not compressed by the autoclave pressure or the counter-form.

Advantageously, if the hollow form determined by the stiffener and the skin is not closed totally, as in the examples of FIGS. 6b and 6d, the core according to the aspects of the disclosed embodiments is extracted, after it has been emptied of the granular solid material, through the longitudinal lateral opening, if such an opening is accessible.

The method can also be applied when the at least one stiffener is made of a composite material that is cured before being deposited in the cavity 82 of the mold 8. For example, the at least one stiffener can be produced, in a first step, by any method that uses composite materials, which may be different from the one that will be used to form the skin of the stiffened panel, and which may be different depending on the stiffener, if two or more stiffeners are used for the production of the stiffened panel. Thus, a stiffener can be produced by curing preimpregnated fibers in the mold, but also, for example, by a resin transfer method RTM or by pultrusion or forming. In this case, the at least one stiffener is deposited in the cavity 82, the core 5 is deposited on the part of the mold 8 that is to rest in the hollow space, and the skin is deposited, as already described.

The at least one stiffener can also be formed from fibers in the cavity 82 of the mold, the core can be positioned, and a skin made of a precured material can be connected to the mold. The at least one stiffener and the skin can also be produced beforehand from a cured material, and assembled by gluing in the mold 8 by the application of the method, where a glue is deposited on the surfaces of the stiffener and/or of the panel which are to be assembled. In these cases, the core is particularly useful to prevent deformations of the skin and of the stiffener during the application of the pressures that are associated with the gluing, which deformations would introduce undesirable residual stresses into the composite material, and even permanent deformations of the stiffened panel.

The method also makes it possible to produce panels that comprise stiffeners on their two faces, where the order in which the fibers of the skin, the fibers of the stiffeners, and the cores are deposited is then determined by the method that is used for forming the stiffened panel.

1. Method for the production of a stiffened panel made of a composite material, where said stiffened panel comprises a skin and at least one stiffener, and where said composite material comprises fibers that are coated with a resin that changes from a pasty or liquid state to a solid state during the curing phase, where said stiffened panel comprises at least one hollow form, which is elongated, i.e., it has one dimension, the length, that is large compared to the other dimensions that are substantially orthogonal to the length, and which is formed by surfaces of the at least one stiffener and of the skin, in which a volume corresponding entirely or in part to the at least one hollow form is occupied by a core, where said core comprises a bladder made of a flexible material presenting an external surface delimiting a volume of the core, whose shapes and dimensions are in agreement with the volume of the hollow form, and present an internal surface determining a volume of the bladder, which volume is filled with a granular solid material chosen from materials having a thermal expansion coefficient that is substantially equal to the thermal expansion coefficient of the composite material used to produce the stiffened panel.

2. Method according to claim 1, in which the core is produced with sections whose dimensions are substantially smaller than the dimensions of the hollow form of the stiffened panel.

3. Method according to claim 2, in which the dimensions of the section of the core correspond to the dimensions of the hollow form that is to be occupied by said core, before the phase of curing the composite material.

4. Method according to claim 1, in which the granular solid material is a material or a mixture of materials whose thermal expansion coefficients are between 3 10E-6 per Kelvin and 9 10E-6 per Kelvin.

5. Method according to claim 4, in which the granular solid material is a borosilicate glass.

6. Method according to claim 4, in which the granular solid material is an iron-nickel alloy of the Invar type with low expansion coefficient.

7. Method according claim 1, in which a pressure Pn of an intergranular fluid contained in the bladder is decreased during a step of preparation of the core, in such a way that the walls of the bladder compact the granular solid material due the effect of crushing forces of the bladder that are connected with the pressure exerted on the external surface of the bladder made of flexible material and confer a stable shape to the core.

8. Method according to claim 1, in which the pressure Pn of an intergranular fluid contained in the bladder is increased, during the phase of curing the resin, in such a way that the pressure in the core Pn balances substantially the forces exerted by the means for the pressurization of the composite material, in such a way that the fibers of the composite material are compressed without being deformed.

9. Method according to claim 8, in which the means for the pressurization of the composite material comprise an external bladder that is subjected to an autoclave pressure Pa, and in which the pressure Pn is increased to a value that is substantially equal to the pressure Pa.

10. Method according to claim 9, in which the intergranular fluid is subjected to the autoclave pressure Pa in such a way that Pn is substantially equal to Pa.

11. Method according to claim 9, in which the pressure Pn of the intergranular fluid is equal to the autoclave pressure Pa, corrected to compensate for the difference between the external surface of the core (5), which is subjected to the autoclave pressure, and the internal surface of the bladder (51), which is subjected to the pressure of the intergranular fluid opposite said external surface that is subjected to the autoclave pressure.

12. Method according to claim 8, in which the pressure Pn of the intergranular fluid is increased to a value that is at least equal to an injection pressure of a resin in a closed mold.

13. Method according to claim 1, in which the resin is cured by thermal curing and its core is filled with a granular solid material and/or an interstitial fluid which are chosen with a thermal conductivity coefficient that can ensure the diffusion of the heat, and the homogeneity of the temperature during the thermal cure.

14. Method according to claim 1, in which the pressure Pn in the bladder of the core is decreased to a value below atmospheric pressure, after it has been emptied, at least partially, of the granular solid material.

15. Stiffened panel made of a composite material, which comprises a skin and at least one stiffener which is fixed to a face of said skin, comprising, during a step of its production, at least one core, which is trapped in the stiffened panel, where said core comprises a flexible bladder that is filled with a granular solid material whose expansion coefficient is close to the expansion coefficient of the composite material of said stiffened panel.

16. Stiffened panel according to claim 15, in which the core is trapped, at least over a part of its length, in a volume having a closed section that is delimited by an internal surface of the section of a stiffener and optionally of a part of the face of the skin to which the stiffener is fixed.

17. Stiffened panel according to claim 15, in which the core is trapped, at least over a part of its length, in a volume having an open section that is delimited by a surface of the section of a stiffener and optionally of a part of the surface of the skin to which the stiffener is fixed.
